(19) United States
(12) Patent Application Publication
(10) Pub. No.: US 2013/0243001 A1
(43) Pub. Date: Sep. 19, 2013

(54) NODE AND METHOD FOR TRANSMITTING AND RECEIVING CONTENT-CENTRIC NETWORK (CCN) PACKET IN CCN

(71) Applicants: Do Jun BYUN, Seoul (KR); Byoung Joon LEE, Seongnam-si (KR); Myeong Wuk JANG, Hwaseong-si (KR)

(72) Inventors: Do Jun BYUN, Seoul (KR); Byoung Joon LEE, Seongnam-si (KR); Myeong Wuk JANG, Hwaseong-si (KR)

(73) Assignee: SAMSUNG ELECTRONICS CO., LTD., Suwon-si (KR)

(21) Appl. No.: 13/803,358

(22) Filed: Mar. 14, 2013

(30) Foreign Application Priority Data
Mar. 16, 2012 (KR) 10-2012-0026944

(51) Int. Cl. H04L 12/70

(52) U.S. Cl. CPC H04L 47/365
USPC 370/392

(57) ABSTRACT

A node and a method for transmitting and receiving a Content-Centric Network (CCN) packet in a CCN are provided. The method of transmitting the CCN packet, includes generating a path being used to transmit a packet with a compressed header. The method further includes determining whether a header of the CCN packet is compressible. The method further includes compressing the header based on a result of the determining. The method further includes transmitting the CCN packet with the compressed header via the path.

### CROSS-REFERENCE TO RELATED APPLICATION(S)

This application claims the benefit under 35 U.S.C. §119(a) of Korean Patent Application No. 10-2012-0026944, filed on Mar. 16, 2012, in the Korean Intellectual Property Office, the entire disclosure of which is incorporated herein by reference for all purposes.

### BACKGROUND

1. Field

The following description relates to a node and a method for transmitting and receiving a Content-Centric Network (CCN) packet in a CCN.

2. Description of Related Art

In a name-based network, a content request packet, namely an interest, includes a hierarchical name of content desired to be fetched. For example, when the content request packet is received, nodes included in the name-based network may transfer the received content request packet to an interface in a direction in which a node, with the content corresponding to the hierarchical name, is located. The node with the content may search for the content based on the hierarchical name, and may transfer the content to the interface through which the content request packet enters so that the content may be transferred to a node requesting the content. Additionally, the nodes included in the name-based network may receive, from the interface, a content response packet, including the content, in response to the content request packet. However, in a Content-Centric Network (CCN), a header of a CCN packet includes a hierarchical name of content desired to be fetched, which may cause issues in a transmission speed, issues in a load, and/or other issues.

### SUMMARY

In one general aspect, there is provided a method of transmitting a Content-Centric Network (CCN) packet in a network, the method including generating a path being used to transmit a packet with a compressed header. The method further includes determining whether a header of the CCN packet is compressible. The method further includes compressing the header based on a result of the determining The method further includes transmitting the CCN packet with the compressed header via the path.

The method may further include compressing the header if the header is determined to be compressible.

The method may further include setting a logical value of a header compression flag of the CCN packet with the compressed header to a first value.

The method may further include generating another path being used to transmit a packet with an uncompressed header. The method may further include transmitting the CCN packet via the other path if the header is determined to be incompressible.

The method may further include setting a logical value of a header compression flag of the CCN packet to a second value if the header is determined to be incompressible.

The method may further include generating a Forwarding Information Base (FIB) entry associated with a name of content of the CCN packet, and another path of the FIB entry that is used to transmit a packet with an uncompressed header.

A non-transitory computer-readable storage medium may store a program including instructions to cause a computer to implement the method.

In another general aspect, there is provided a method of receiving a Content-Centric Network (CCN) packet in a network, the method including determining which one of a primary path and a secondary path is used to receive the CCN packet, the primary path being used to transfer a packet with an uncompressed header, and the secondary path being used to transfer a packet with a compressed header. The method further includes processing the CCN packet based on a result of the determining.

The processing may include decompressing a header of the CCN packet if the secondary path is determined to be used to receive the CCN packet.

The method may further include verifying a logical value of a header compression flag of the CCN packet.

A non-transitory computer-readable storage medium may store a program including instructions to cause a computer to implement the method.

In still another general aspect, there is provided a node configured to transmit a Content-Centric Network (CCN) packet in a network, the node including a generating unit configured to generate a path being used to transmit a packet with a compressed header. The node further includes a determining unit configured to determine whether a header of the CCN packet is compressible. The node further includes a compressing unit configured to compress the header based on a result of the determination of the determining unit. The node further includes a transmitting unit configured to transmit the CCN packet with the compressed header via the path.

The compressing unit may be further configured to compress the header if the header is determined to be compressible.

The node may further include a setting unit configured to set a logical value of a header compression flag of the CCN packet with the compressed header to a first value.

The generating unit may be further configured to generate another path being used to transmit a packet with an uncompressed header. The transmitting unit may be further configured to transmit the CCN packet via the other path if the header is determined to be incompressible.

The node may further include a setting unit configured to set a logical value of a header compression flag of the CCN packet to a second value if the header is determined to be incompressible.

The generating unit may be further configured to generate a Forwarding Information Base (FIB) entry associated with a name of content of the CCN packet, and another path of the FIB entry that is used to transmit a packet with an uncompressed header.

In yet another general aspect, there is provided a node configured to receive a Content-Centric Network (CCN) packet in a network, the node including a determining unit configured to determine which one of a primary path and a secondary path is used to receive the CCN packet, the primary path being used to transfer a packet with an uncompressed header, and the secondary path being used to transfer a packet with a compressed header. The node further includes a processing unit configured to process the CCN packet based on a result of the determination of the determining unit.

The processing unit may be further configured to decompress a header of the CCN packet if the secondary path is determined to be used to receive the CCN packet.

The node may further include a verifying unit configured to verify a logical value of a header compression flag of the CCN packet.

In another general aspect, there is provided a node including a receiving unit configured to receive a packet. The node further includes a determining unit configured to determine that the packet includes a compressed header. The node further includes a processing unit configured to process the packet based on a result of the determination of the determining unit.

Other features and aspects will be apparent from the following detailed description, the drawings, and the claims.

### BRIEF DESCRIPTION OF THE DRAWINGS

FIG. 1 is a diagram illustrating an example of a method of processing a content request packet in a Content-Centric Network (CCN).

FIG. 2 is a diagram illustrating an example of a primary face and a secondary face in a CCN.

FIG. 3 is a flowchart illustrating an example of a method of transmitting a CCN packet in a CCN based on a name of content.

FIG. 4 is a flowchart illustrating an example of a method of receiving a CCN packet in a CCN based on a name of content.

FIG. 5 is a flowchart illustrating an example of a method of transmitting and receiving a CCN packet between a transmission node and a reception node in a CCN.

FIG. 6 is a block diagram illustrating an example of a node configured to transmit a CCN packet in a CCN based on a name of content.

FIG. 7 is a block diagram illustrating an example of a node configured to receive a CCN packet in a CCN based on a name of content.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, description of well-known functions and constructions may be omitted for increased clarity and conciseness.

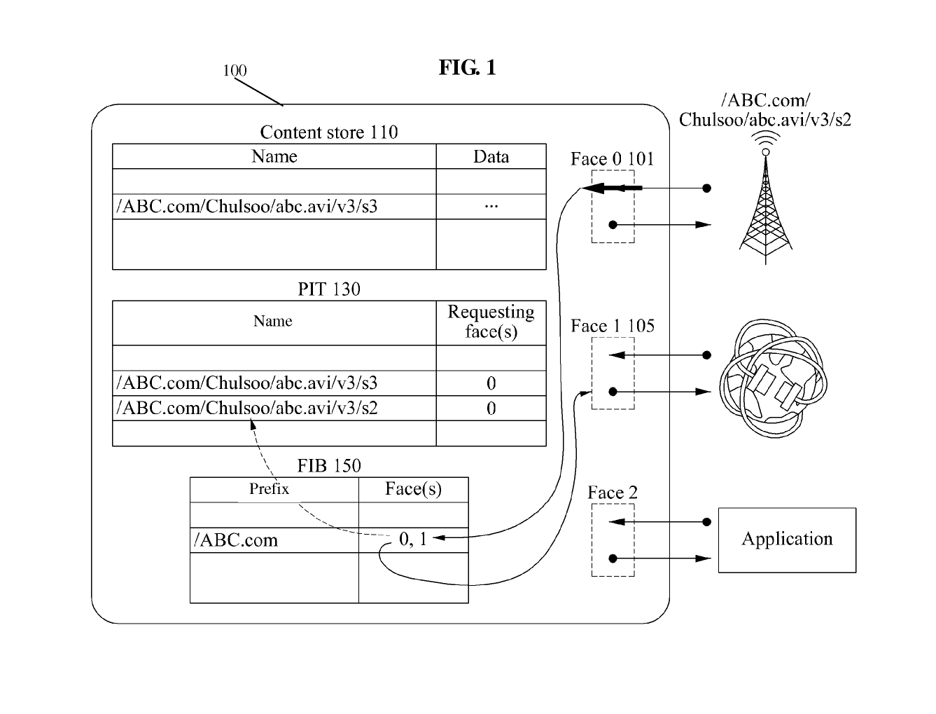

FIG. 1 illustrates an example of a method of processing a content request packet in a Content-Centric Network (CCN). In the CCN, a name of content functions as a compass to search for a node in which the content is stored, and functions to distinguish the content from other contents. Accordingly, each of contents is associated its own name. When names of two contents are different from each other, the two contents are determined to be different contents, despite the same information being included in the two contents. For example, when two files include the same information, but include different names, namely ‘/ABC.com/sait/video/intro.avi’ and ‘/ABC.com/sait/comm/video/intro.avi’, the two files are processed as different contents. The above rule is useful in distinguishing different contents with similar names.

FIG. 1 illustrates the method of processing a content request packet in the CCN, namely a name-based network, to fetch a content based on a hierarchical name of the content included in the content request packet. For example, referring to FIG. 1, a node 100 included in the CCN receives, via a face 0 101 from, e.g., another node, a content request packet requesting a content corresponding to a hierarchical name of the content, for example, ‘/ABC.com/Chulsoo/abc.avi/v3/s2’. The hierarchical name of the content may is included in the content request packet.

In this example, a networking module of the node 100 determines whether the requested content (i.e., data) is included in a content store 110 of the node 100 based on the hierarchical name of the content, ‘/ABC.com/Chulsoo/abc.avi/v3/s2’. If the requested content is determined to be stored in the content store 110, the node 100 returns the requested content to the face 0 101 used to receive the content request packet. The term “face” may be used interchangeably with the term “interface” and the term “path”. If the requested content is determined not to be stored in the content store 110, as shown in FIG. 1, the node 100 determines whether an entry stored with the hierarchical name of the content, ‘/ABC.com/Chulsoo/abc.avi/v3/s2’, is included in a Pending Interest Table (PIT) 130 of the node 100.

If the entry is determined to be included in the PIT 130, as shown in FIG. 1, the node 100 adds information on the face 0 101 (i.e., a requesting face) to the entry in the PIT 130 (i.e., a requesting face(s) column). If the entry is determined not to be included in the PIT 130, the node 100 further searches for the entry by performing a lookup in a Forwarding Information Base (FIB) 150 based on the hierarchical name of the content. In this example, the node 100 further searches for the entry based on longest-prefix-matching of one of longest prefixes of contents included in the FIB 150 and a longest prefix of the hierarchical name.

If there is the longest-prefix-matching, as shown in FIG. 1, the node 100 selects a face 1 105 from information registered in the FIB 150 (i.e., a face(s) column) that corresponds to the matched one of the longest prefixes (i.e., ‘/ABC.com’). The face 1 105 is selected based on whether a header of the content request packet is compressible, as described herein. The node 100 transmits the content request packet to, e.g., another node and/or an application, via the selected face 1 105.

In this example, the node 100 registers, in the PIT 130, information ‘0’ on the face 0 101 so that a data packet including the content corresponding to the content request packet may be enabled to be transferred to a node requesting the content. Additionally, one of faces other than the face 1 105 (e.g., a face 2) may be selected, based on the FIB 150, as a face enabling the content request packet to be transferred.

Hereinafter, a CCN packet may include both a content request packet and a content response packet responding to the content request packet.

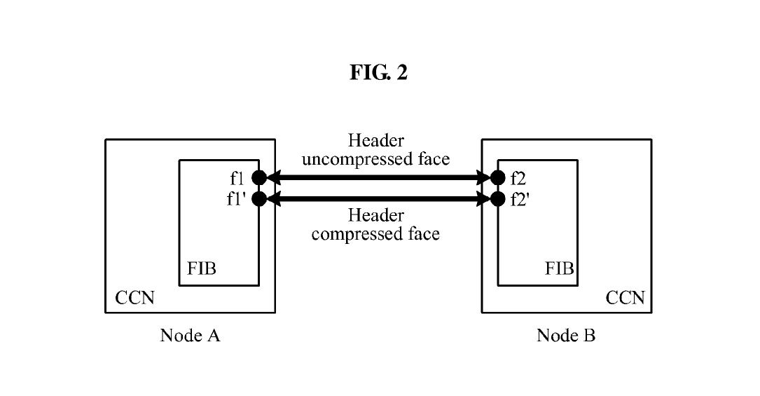

FIG. 2 illustrates an example of a primary face and a secondary face in a CCN. The primary face may be used to transfer a packet in which a header is uncompressed. The secondary face may be used to transfer a packet in which a header is compressed. In each node of the CCN, a packet with an uncompressed header, and a packet with a compressed header, may be transmitted via different faces, e.g., the primary face and the secondary face, respectively.

In an example in which a header of a CCN packet to be transmitted is uncompressed, a node A transmits the CCN packet to a node B via a primary face f1. In another example in which a header of a CCN packet to be transmitted is compressed, the node A transmits the CCN packet to the node B via a secondary face f1′. Similarly, the node B receives the CCN packet with the uncompressed header from the node A via a primary face f2, and receives the CCN packet with the compressed header from the node A via a secondary face f2′.

As described above, faces via which CCN packets are transferred may be separately selected based on FIBs in the node A and the node B. Thus, it is possible to easily determine whether a header of a CCN packet is uncompressed or compressed based on only a packet transmission route, e.g., faces used.

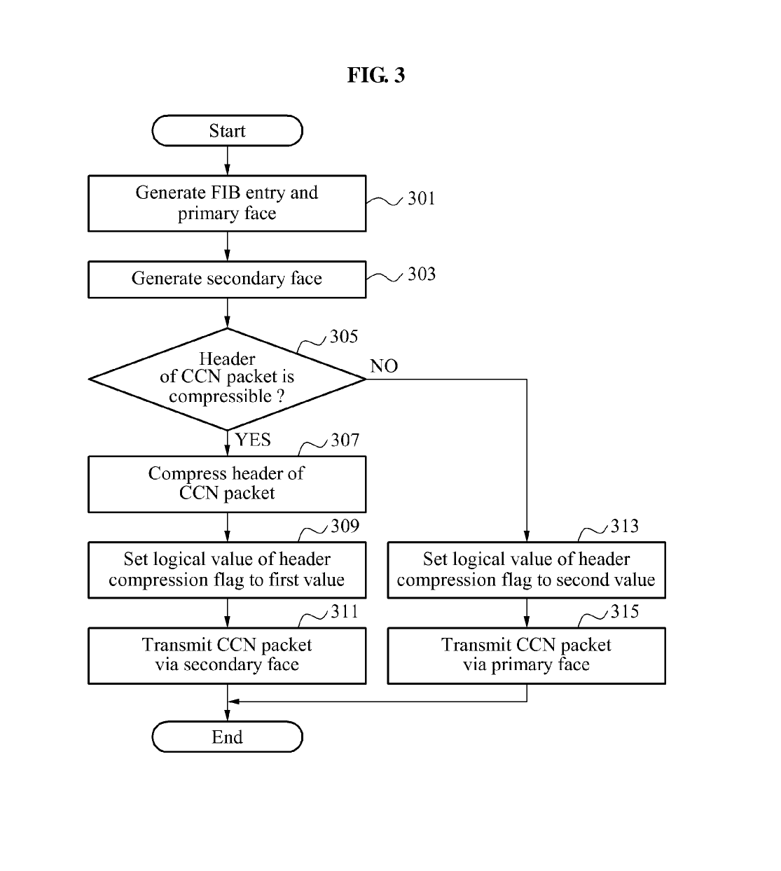

FIG. 3 illustrates an example of a method of transmitting a CCN packet in a CCN based on a name of content. Referring to FIG. 3, in operation 301, a node configured to transmit the CCN packet, hereinafter referred to as a transmission node, generates a FIB entry associated with content(s) of the CCN packet, and a primary face of the FIB entry. A FIB stores one or more entries associated with respective contents (i.e., names of contents) of CCN packets, and including respective primary and secondary faces. The primary face is used to transfer a packet with an uncompressed header.

In operation 303, the transmission node generates a secondary face of the FIB entry. The secondary face is used to transfer a packet with a compressed header.

In operation 305, the transmission node determines whether a header of the CCN packet to be transmitted is compressible. For example, if the CCN packet is an already-compressed file, and/or is a file that is not allowed to be compressed due to various reasons, the transmission node determines the header of the CCN packet to be incompressible. Due to other various reasons, the transmission node may also determine the header of the CCN packet to be incompressible.

If the header of the CCN packet is determined to be compressible, in operations 307 through 311, the transmission node transmits the CCN packet with a compressed header to, e.g., another node and/or an application, via the secondary face. In more detail, in operation 307, the transmission node compresses the header of the CCN packet. In operation 309, the transmission node sets a logical value of a header compression flag of the CCN packet to a first value (for example, ‘1’ or “true”). In operation 311, the transmission node transmits the CCN packet with the compressed header via the secondary face.

If the header of the CCN packet is determined to be incompressible, in operation 313, the transmission node sets the logical value of the header compression flag of the CCN packet to a second value (for example, ‘0’ or “false”). In operation 315, the transmission node transmits the CCN packet with an uncompressed header to, e.g., another node and/or an application, via the primary face.

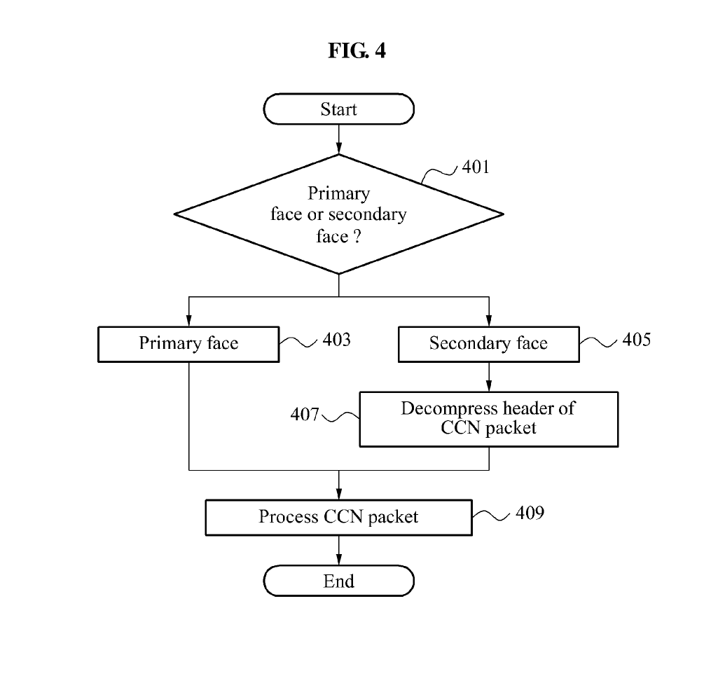

FIG. 4 illustrates an example of a method of receiving a CCN packet in a CCN based on a name of content. Referring to FIG. 4, in operation 401, a node configured to receive the CCN packet, hereinafter referred to as a reception node, determines which one of a primary face and a secondary face is used to receive the CCN packet from a transmission node. The primary face is used to transfer a packet with an uncompressed header, and the secondary face is used to transfer a packet with a compressed header.

In operation 403, the reception nodes determines that the primary face is used to receive the CCN packet with an uncompressed header. In this example, in operation 409, the reception node processes the received CCN packet directly without decompressing the uncompressed header of the CCN packet.

In operation 405, the reception nodes determines that the secondary face is used to receive the CCN packet with a compressed header. In operation 407, the reception node decompresses the compressed header of the CCN packet. In this example, in operation 409, the reception node processes the received CCN packet after decompressing the compressed header of the CCN packet.

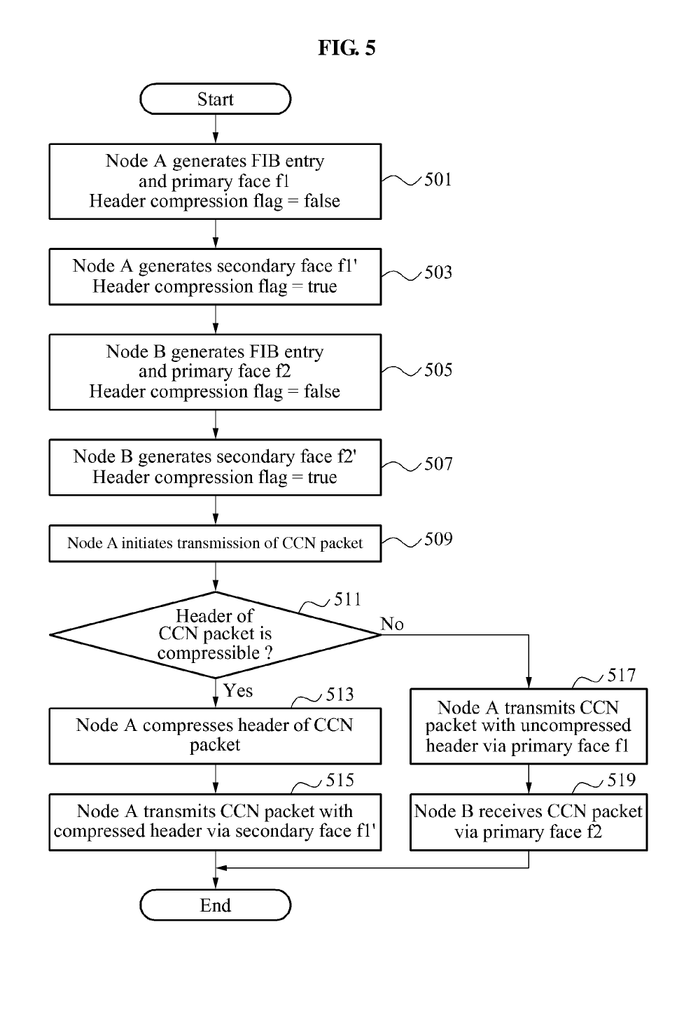

FIG. 5 illustrates an example of a method of transmitting and receiving a CCN packet between a transmission node and a reception node in a CCN. Referring to FIG. 5, in operation 501, a node A, as a transmission node, generates a FIB entry associated with content(s) of the CCN packet, and a primary face f1 of the FIB entry that is used to transmit a packet with an uncompressed header. The node A further sets a logical value of a header compression flag of a CCN packet to be transmitted via the primary face f1 to “false”.

In operation 503, the node A generates a secondary face f1′ of the FIB entry that is used to transfer a packet with a compressed header. The node A further sets a logical value of a header compression flag of a CCN packet to be transmitted via the secondary face f1′ to “true”.

Similarly to the node A, in operation 505, a node B, as a reception node, generates a FIB entry and a primary face f2 of the FIB entry that is used to receive a packet with an uncompressed header. The node B further sets a logical value of a header compression flag of a CCN packet to be received via the primary face f2 to “false”.

In operation 507, the node B generates a secondary face f2′ of the FIB entry that is used to receive a packet with a compressed header. The node B further sets a logical value of a header compression flag of a CCN packet to be received via the secondary face f2′ to “true”.

In operation 509, the node A initiates transmission of the CCN packet to the node B. In operation 511, the node A determines whether a header of the CCN packet is compressible. If the header of the CCN packet is determined to be compressible, in operation 513, the node A compresses the header of the CCN packet. In operation 515, the node A transmits the CCN packet with the compressed header to the node B via the secondary face f1′.

If the header of the CCN packet is determined to be incompressible, in operation 517, the node A transmits the CCN packet with the uncompressed header to the node B via the primary face f1. In operation 519, the node B receives the CCN packet with the uncompressed header from the node A via the primary face f2. Since the header compression flag of the CCN packet received via the primary face f2 is set to “false”, the node B processes the CCN packet directly without decompressing the uncompressed header of the CCN packet.

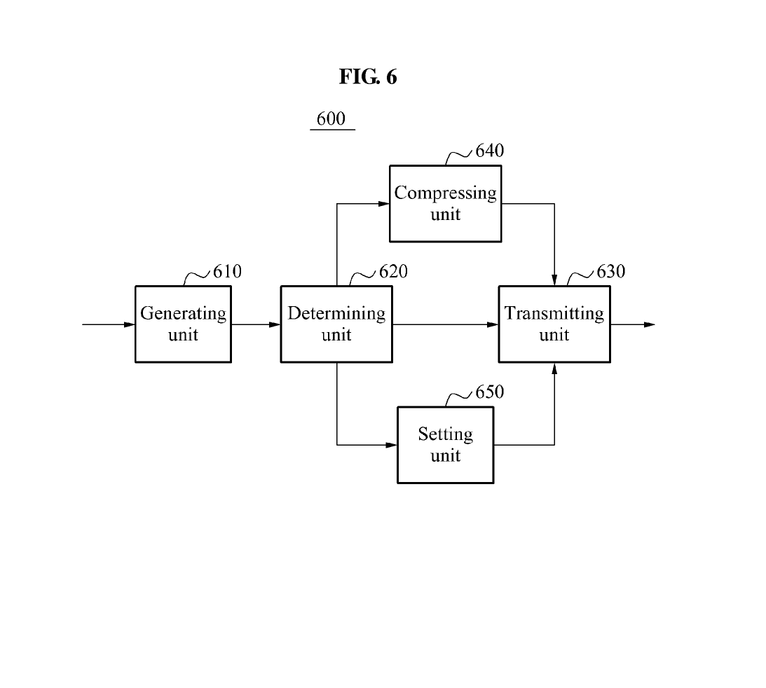

FIG. 6 illustrates an example of a node 600 configured to transmit a CCN packet in a CCN based on a name of content. Referring to FIG. 6, the node 600 includes a generating unit 610, a determining unit 620, a transmitting unit 630, a compressing unit 640, and a setting unit 650.

The generating unit 610 generates a FIB entry associated with content(s) of the CCN packet, and a primary face of the FIB entry. A FIB stores one or more entries associated with respective contents (i.e., names of the contents) of CCN packets, and including respective primary and secondary faces. The primary face is used to transfer a packet with an uncompressed header. Additionally, the generating unit 610 generates a secondary face of the FIB entry that is used to transfer a packet with a compressed header.

The determining unit 620 determines whether a header of the CCN packet to be transmitted is compressible. The transmitting unit 630 transmits the CCN packet to, e.g., another node and/or an application, based on a result of the determination of the determining unit 620. For example, if the header of the CCN packet is determined to be incompressible, the transmitting unit 630 transmits the CCN packet in which the header is uncompressed via the primary face. If the header of the CCN packet is determined to be compressible, the transmitting unit 630 transmits the CCN packet in which the header is compressed via the secondary face.

The compressing unit 640 compresses the header of the CCN packet if the header of the CCN packet is determined to be compressible. The compressing unit 640 transmits the compressed header of the CCN packet to the transmitting unit 630.

The setting unit 650 sets a logical value of a header compression flag of the CCN packet to a first value (for example, ‘1’ or “true”) if the header of the CCN packet is determined to be compressible. Additionally, the setting unit 650 sets a logical value of a header compression flag of the CCN packet to a second value (for example, ‘0’ or “false”) if the header of the CCN packet is determined to be incompressible.

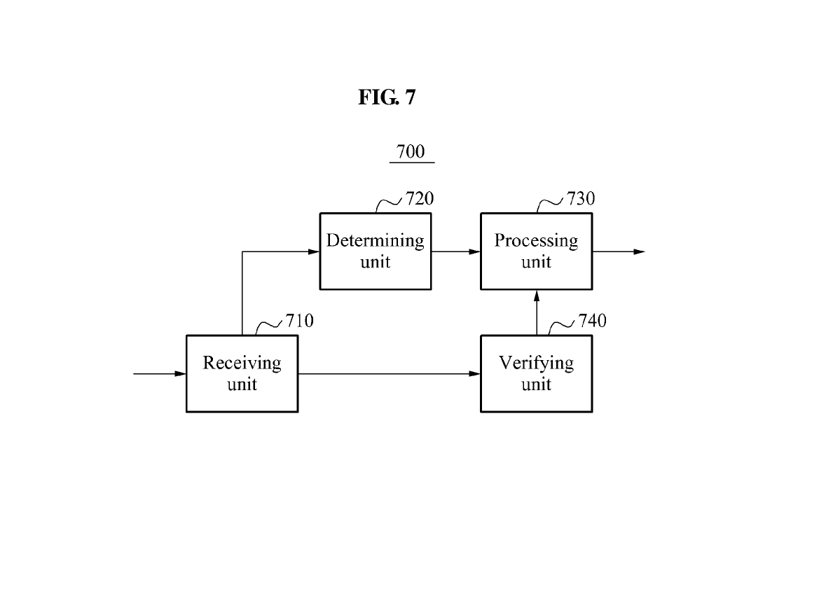

FIG. 7 illustrates an example of a node 700 configured to receive a CCN packet in a CCN based on a name of content. Referring to FIG. 7, the node 700 includes a receiving unit 710, a determining unit 720, a processing unit 730, and a verifying unit 740.

The receiving unit 710 receives the CCN packet. The determining unit 720 determines which one of a primary face and a secondary face is used by the receiving unit 710 to receive the CCN packet. The primary face is used to transfer a packet with an uncompressed header, and the secondary face is used to transfer a packet with a compressed header.

The processing unit 730 processes the received CCN packet based on a result of the determination of the determining unit 720. For example, if the secondary face is determined to be used to receive the CCN packet, the processing unit 730 decompresses a header of the received CCN packet. If the primary face is determined to be used to receive the CCN packet, the processing unit 730 processes the received CCN packet without decompressing the header of the received CCN packet.

The verifying unit 740 verifies a logical value of a header compression flag of the received CCN packet. In more detail, the verifying unit 740 determines whether the logical value is set to a first value (for example, ‘1’ or “true”) indicating that the header of the received CCN packet is determined to be compressible, or a second value (for example, ‘0’ or “false”) indicating that the header of the received CCN packet is determined to be incompressible. The processing unit 730 may process the received CCN packet based on the result of the determination of the determining unit 720 and a result of the verification of the verifying unit 740. For example, if the secondary face is determined to be used to receive the CCN packet, and the logical value is set to the first value, the processing unit 730 decompresses a header of the received CCN packet. If the primary face is determined to be used to receive the CCN packet, and the logical value is set to the second value, the processing unit 730 processes the received CCN packet without decompressing the header of the received CCN packet.

According to the teachings above above, there is provided a node and a method for transmitting and receiving a CCN packet in a CCN, which compresses content in a header of the CCN packet to reduce a size of the header. Accordingly, it is possible to reduce a transmission overhead of the header of the CCN packet, and to improve a transmission speed and a transmission efficiency. Additionally, a primary face used to transfer a packet with an uncompressed header, and a secondary face used to transfer a packet with a compressed header, are separately generated, and thus, it is possible to easily determine whether a header of a CCN packet is compressed based on only a packet transmission route, e.g., faces used. Furthermore, a logical value of a header compression flag of a CCN packet with an uncompressed header is set to be different from a logical value of a header compression flag of a CCN packet with a compressed header, and thus, it is possible to easily determine whether a header of a CCN packet is compressed based on a header compression flag of the CCN packet.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable recording mediums. The computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments accomplishing the examples disclosed herein can be easily construed by programmers skilled in the art to which the examples pertain based on and using the flow diagrams and block diagrams of the figures and their corresponding descriptions as provided herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of transmitting a Content-Centric Network (CCN) packet in a network, the method comprising:
generating a path being used to transmit a packet with a compressed header;
determining whether a header of the CCN packet is compressible;
compressing the header based on a result of the determining; and
transmitting the CCN packet with the compressed header via the path.

2. The method of claim 1, further comprising:
compressing the header if the header is determined to be compressible.

3. The method of claim 1, further comprising:
setting a logical value of a header compression flag of the CCN packet with the compressed header to a first value.

4. The method of claim 1, further comprising:
generating another path being used to transmit a packet with an uncompressed header; and
transmitting the CCN packet via the other path if the header is determined to be incompressible.

5. The method of claim 1, further comprising:
setting a logical value of a header compression flag of the CCN packet to a second value if the header is determined to be incompressible.

6. The method of claim 1, further comprising:
generating a Forwarding Information Base (FIB) entry associated with a name of content of the CCN packet, and another path of the FIB entry that is used to transmit a packet with an uncompressed header.

7. A non-transitory computer-readable storage medium storing a program comprising instructions to cause a computer to implement the method of claim 1.

8. A method of receiving a Content-Centric Network (CCN) packet in a network, the method comprising:
determining which one of a primary path and a secondary path is used to receive the CCN packet, the primary path being used to transfer a packet with an uncompressed header, and the secondary path being used to transfer a packet with a compressed header; and
processing the CCN packet based on a result of the determining.

9. The method of claim 8, wherein the processing comprises:
decompressing a header of the CCN packet if the secondary path is determined to be used to receive the CCN packet.

10. The method of claim 8, further comprising:
verifying a logical value of a header compression flag of the CCN packet.

11. A non-transitory computer-readable storage medium storing a program comprising instructions to cause a computer to implement the method of claim 8.

12. A node configured to transmit a Content-Centric Network (CCN) packet in a network, the node comprising:
a generating unit configured to generate a path being used to transmit a packet with a compressed header;
a determining unit configured to determine whether a header of the CCN packet is compressible;
a compressing unit configured to compress the header based on a result of the determination of the determining unit; and
a transmitting unit configured to transmit the CCN packet with the compressed header via the path.

13. The node of claim 12, wherein the compressing unit is further configured to:
compress the header if the header is determined to be compressible.

14. The node of claim 12, further comprising:
a setting unit configured to set a logical value of a header compression flag of the CCN packet with the compressed header to a first value.

15. The node of claim 12, wherein:
the generating unit is further configured to generate another path being used to transmit a packet with an uncompressed header; and
the transmitting unit is further configured to transmit the CCN packet via the other path if the header is determined to be incompressible.

16. The node of claim 12, further comprising:
a setting unit configured to set a logical value of a header compression flag of the CCN packet to a second value if the header is determined to be incompressible.

17. The node of claim 12, wherein the generating unit is further configured to:
generate a Forwarding Information Base (FIB) entry associated with a name of content of the CCN packet, and another path of the FIB entry that is used to transmit a packet with an uncompressed header.

18. A node configured to receive a Content-Centric Network (CCN) packet in a network, the node comprising:
a determining unit configured to determine which one of a primary path and a secondary path is used to receive the CCN packet, the primary path being used to transfer a packet with an uncompressed header, and the secondary path being used to transfer a packet with a compressed header; and
a processing unit configured to process the CCN packet based on a result of the determination of the determining unit.

19. The node of claim 18, wherein the processing unit is further configured to:
decompress a header of the CCN packet if the secondary path is determined to be used to receive the CCN packet.

20. The node of claim 18, further comprising:
a verifying unit configured to verify a logical value of a header compression flag of the CCN packet.

21. A node comprising:
a receiving unit configured to receive a packet;
a determining unit configured to determine that the packet comprises a compressed header; and
a processing unit configured to process the packet based on a result of the determination of the determining unit.
